(19) United States
(12) Patent Application Publication
(10) Pub. No.: US 2026/0175597 A1
(43) Pub. Date: Jun. 25, 2026

(54) MEDIUM PROCESSING APPARATUS AND PRINTING APPARATUS

(71) Applicant: SEIKO EPSON CORPORATION, Tokyo (JP)

(72) Inventor: Tomohiro YODA, MATSUMOTO-SHI (JP)

(21) Appl. No.: 19/426,884

(22) Filed: Dec. 19, 2025

(30) Foreign Application Priority Data
Dec. 24, 2024 (JP) 2024-227106

(51) Int. Cl. B41J 11/00; B41J 29/377

(52) U.S. Cl. CPC B41J 11/0022; B41J 11/0024; B41J 29/377

(57) ABSTRACT

A medium processing apparatus includes a medium support section configured to support a medium conveyed through a conveyance path, and a drying unit configured to face the medium support section across the medium supported by the medium support section and dry ink adhering to the medium, wherein the drying unit includes a housing provided with a heater disposed at a distance from the medium and configured to heat the medium in a heating region, a blast port configured to send out a gas brown toward the medium and then flowing along the medium, an intake port configured to take in the gas passing through the heating region, a communication flow path configured to communicate the blast port and the intake port with each other to allow the gas to flow, and a collection path located downstream of the intake port in a direction in which the gas flows along the medium and configured to collect a part of the gas not taken in the intake port.

The present application is based on, and claims priority from JP Application Serial Number 2024-227106, filed December 24, 2024, the disclosure of which is hereby incorporated by reference herein in its entirety.

### BACKGROUND

### 1. Technical Field

The present disclosure relates to a medium processing apparatus and a printing apparatus.

### 2. Related Art

JP-A-2019-064124 discloses a heating apparatus, a medium processing apparatus, and a method of processing a medium which are capable of suitably discharging vapor generated from the medium. The medium processing apparatus disclosed in JP-A-2019-064124 includes a support surface that supports the medium downstream of a recording unit in a conveyance direction in which the medium to which a liquid is attached by the recording unit is conveyed, a heater that heats the medium supported by the support surface, a flow path having an inflow port and a blowoff port that opens toward the support surface, and a blower that is disposed in the flow path and blows out, from the blowoff port, a gas that has inflowed from the inflow port, wherein the inflow port opens so that at least a part of the gas that has blown out from the blowoff port flows therein, the blowoff port is located at a side where the recording unit is located with respect to the inflow port, and a blowoff direction faces to a side where the inflow port is located in a direction along the support surface.

JP-A-2019-064124 is an example of the related art.

In such a medium processing apparatus as disclosed in JP-A-2019-064124, an evaporation component generated due to overheating of the medium is discharged to an outside of that apparatus. Therefore, in such a medium processing apparatus, the evaporation component discharged to the outside of the apparatus may be condensed at the installation location of that apparatus.

### SUMMARY

An aspect for solving the problem described above is a medium processing apparatus including a medium support section configured to support the medium conveyed through a conveyance path, and a drying unit configured to face the medium support section across the medium supported by the medium support section and dry the ink adhering to the medium, wherein the drying unit includes a housing provided with a heater disposed at a distance from the medium and configured to heat the medium in a heating region, a blast port configured to send out a gas brown toward the medium and then flowing along the medium, an intake port configured to take in the gas passing through the heating region, a communication flow path configured to communicate the blast port and the intake port with each other to allow the gas to flow, and a collection path located downstream of the intake port in a direction in which the gas flows along the medium and configured to collect a part of the gas not taken in the intake port.

Another aspect for solving the problem described above is a printing apparatus including an ejection unit configured to eject ink onto a medium, a medium conveyance unit configured to convey the medium, a medium support section configured to support the medium conveyed through a conveyance path, and a drying unit configured to face the medium support section across the medium supported by the medium support section and dry the ink adhering to the medium, wherein the drying unit includes a housing provided with a heater disposed at a distance from the medium and configured to heat the medium in a heating region, a blast port configured to send out a gas brown toward the medium and then flowing along the medium, an intake port configured to take in the gas passing through the heating region, a communication flow path configured to communicate the blast port and the intake port with each other to allow the gas to flow, and a collection path located downstream of the intake port in a direction in which the gas flows along the medium and configured to collect a part of the gas not taken in the intake port.

### BRIEF DESCRIPTION OF THE DRAWINGS

FIG. 1 is a side view schematically showing a printing apparatus according to an embodiment of the present disclosure.

FIG. 2 is a side view schematically showing a medium processing apparatus.

FIG. 3 is a plan view schematically showing the medium processing apparatus.

FIG. 4 is a temperature distribution diagram when the medium processing apparatus is driven.

FIG. 5 is a humidity distribution diagram when the medium processing apparatus is driven.

FIG. 6 is a side view schematically showing a medium processing apparatus according to a modified example.

### DESCRIPTION OF EMBODIMENTS

An embodiment of the present disclosure will hereinafter be described with reference to the drawings.

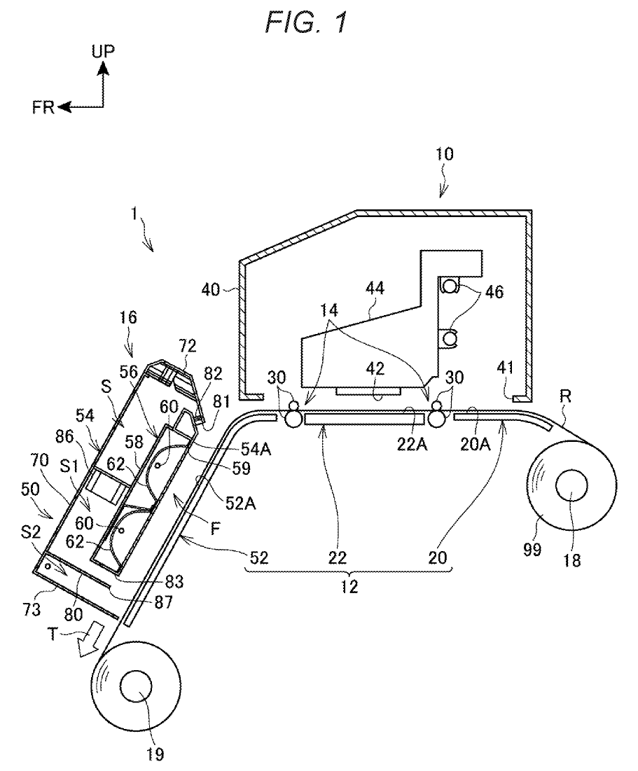

FIG. 1 is a side view schematically illustrating a printing apparatus 1 according to an embodiment of the present disclosure. In FIG. 1, reference characters FR represent a front side of the printing apparatus 1 in a state of being installed at an installation surface to be normally used, and reference characters UP represent an upper side of the printing apparatus 1. In the following description, a direction orthogonal to a front-rear direction and an up-down direction of the printing apparatus 1 is defined as a left-right direction of the printing apparatus 1, and directions are each along one of these directions of the printing apparatus 1. The up-down direction coincides with a vertical direction, and the front-rear direction and the left-right direction coincide with a horizontal direction.

In FIG. 1, a cross-section on a plane perpendicular to the left-right direction of a printing unit 10 and a cross-section on that plane of a drying unit 50 are shown. In FIG. 1, a conveyance direction T in the printing apparatus 1 is indicated by the arrow T.

As illustrated in FIG. 1, the printing apparatus 1 is, for example, an inkjet printer that records an image such as a character or a photograph on a print medium 99 as a medium by jetting ink as an example of a liquid. The print medium 99 is, for example, a roll of paper formed by rolling print paper in a cylindrical shape.

The printing apparatus 1 includes the printing unit 10 that performs printing on the print medium 99, a support section 12 that supports the print medium 99, a conveyance unit 14 that conveys the print medium 99 along the support section 12, and a medium processing apparatus 16 that heats the print medium 99.

In the printing apparatus 1, there is formed a conveyance path R in which one end of the print medium 99 attached to a roll shaft 18 is pulled out, conveyed by the conveyance unit 14 in a state of being supported by some portions of the support section 12, and then wound around a winding shaft 19. The print medium 99 is printed by the printing unit 10 and then heated by the medium processing apparatus 16 while being conveyed along the conveyance path R.

In the following description, in the conveyance path R, a direction in which the print medium 99 is conveyed is referred to as the conveyance direction T.

The medium processing apparatus 16 is an example of a "medium processing apparatus".

The support section 12 includes a first support plate 20 and a second support plate 22. Each of the first support plate 20 and the second support plate 22 is a member formed in a plate shape. In the printing apparatus 1, the first support plate 20 and the second support plate 22 are arranged in this order from upstream in the conveyance direction T of the print medium 99 conveyed by the conveyance unit 14. At least a part of a support surface 20A, which is one surface of the first support plate 20, and a support surface 22A, which is one surface of the second support plate 22, are disposed so as to face to substantially the same direction, and support the print medium 99 from below in the conveyance path R. In the present embodiment, at least a part of the support surface 20A and the support surface 22A are surfaces facing vertically upward.

The conveyance unit 14 includes, for example, a plurality of conveyance rollers 30 that convey the print medium 99 by rotating in a state of being in contact with the print medium 99. In the present embodiment, the conveyance roller 30 is disposed at a position adjacent to each of both ends of the second support plate 22 in the conveyance direction T of the print medium 99. The conveyance roller 30 located upstream in the conveyance direction T of the second support plate 22 is disposed between the first support plate 20 and the second support plate 22.

The conveyance direction T of the print medium 99 conveyed by the conveyance unit 14 is a direction along the support surface 20A and the support surface 22A. Note that the conveyance unit 14 includes two conveyance rollers 30 in the present embodiment, but this is not a limitation, and a single conveyance roller 30 or three or more conveyance rollers 30 may be provided as long as the print medium 99 can be conveyed.

The printing unit 10 includes a printing unit housing 40. An opening 41 that communicates the inside and the outside of the printing unit housing 40 is provided to one surface of the printing unit housing 40. The printing unit housing 40 is disposed so as to form a gap with the support section 12 to provide the opening 41.

A head 42 that jets the liquid, a carriage 44 that holds the head 42, and guide shafts 46 that guide movement of the carriage 44 are disposed inside the printing unit housing 40. The liquid jetted from the head 42 is, for example, the ink. The head 42 is disposed at a position where the head 42 can face the second support plate 22, and jets the liquid onto the print medium 99 supported by the second support plate 22. In the printing apparatus 1, an image is printed on the print medium 99 by the printing unit 10 jetting the liquid onto the print medium 99. The head 42 jets the ink while reciprocating together with the carriage 44 along the guide shafts 46 extending in a width direction of the print medium 99. Note that the width direction of the print medium 99 is a direction that is different from the conveyance direction of the print medium 99 but coincides with the left-right direction of the printing apparatus 1.

The medium processing apparatus 16 performs processing of drying the print medium 99 by heating the print medium 99 to which the liquid is attached by the printing unit 10 to evaporate the liquid attached to the print medium 99 by the heating, and blowing air to the print medium 99.

The medium processing apparatus 16 includes the drying unit 50 and a third support plate 52.

The third support plate 52 is an example of a "medium support section".

The third support plate 52 is a member formed in a plate shape. In the printing apparatus 1, the third support plate 52 is disposed downstream in the conveyance direction T of the second support plate 22. A support surface 52A, which is one surface of the third support plate 52, supports the print medium 99 to which the liquid is attached by the head 42 downstream of the head 42. In the present embodiment, the support surface 52A is a surface facing vertically upward.

The third support plate 52 in the present embodiment obliquely extends in a direction between a direction from upstream toward downstream in the conveyance direction T of the print medium 99 and a direction from the vertically upper side toward the vertically lower side. That is, the third support plate 52 is disposed such that an upstream portion is located vertically above a downstream portion in the conveyance direction. Therefore, the support surface 52A of the third support plate 52 is an inclined surface.

The conveyance roller 30 located downstream in the conveyance direction T of the second support plate 22 is disposed between the second support plate 22 and the third support plate 52.

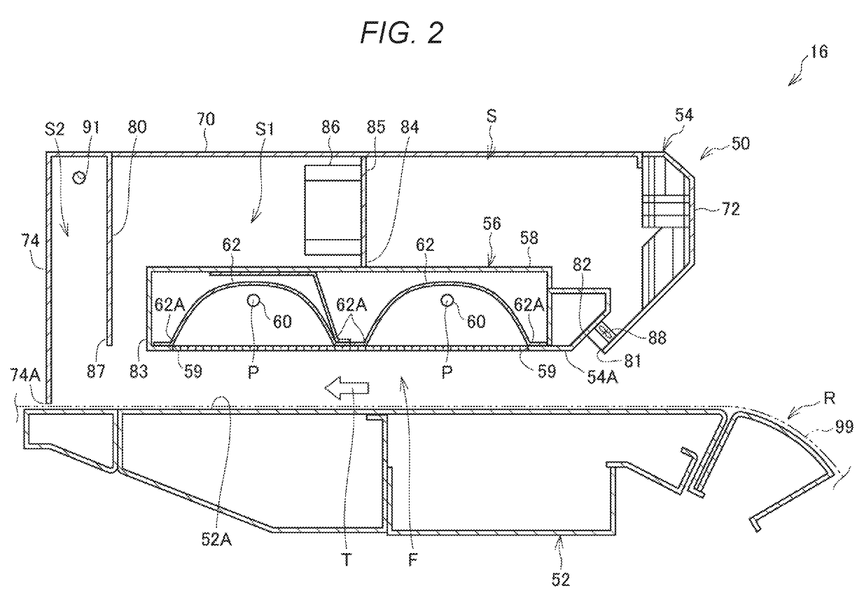

FIG. 2 is a side view schematically illustrating the medium processing apparatus 16. In FIG. 2, a cross-section on a plane perpendicular to the left-right direction of the drying unit 50 is shown.

As illustrated in FIGS. 1 and 2, the drying unit 50 includes a drying unit housing 54. The drying unit housing 54 is disposed such that an opposed surface 54A as one of the surfaces of the drying unit housing 54 faces the support surface 52A of the third support plate 52. The drying unit housing 54 is disposed at a distance from the support surface 52A. The print medium 99 conveyed by the conveyance unit 14 passes through a region between the support surface 52A and the drying unit 50. The drying unit 50 heats the print medium 99 to which the liquid is attached by the head 42 and which is conveyed by the conveyance unit 14.

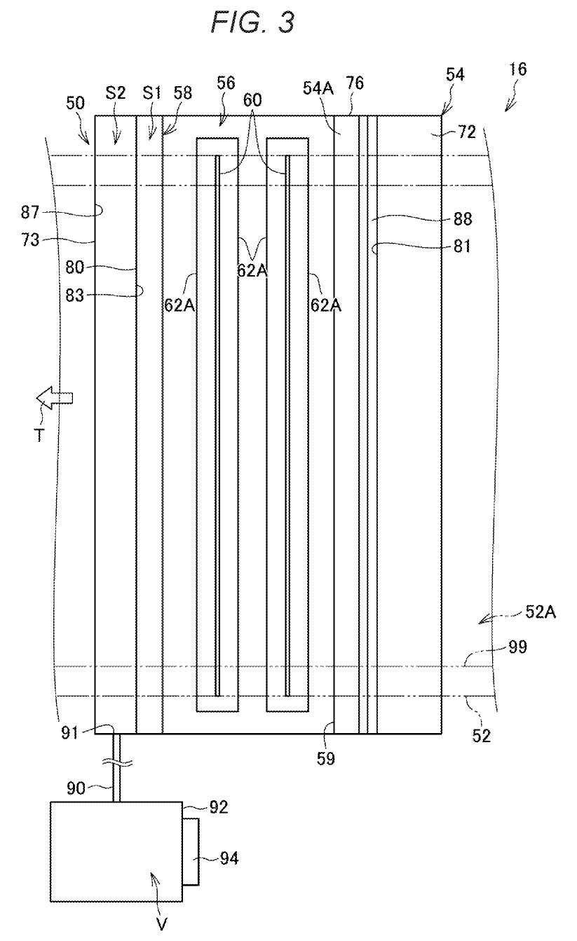

FIG. 3 is a plan view schematically illustrating the medium processing apparatus 16. FIG. 3 is a diagram of the medium processing apparatus 16 viewed from the support surface 52A.

As illustrated in FIGS. 2 and 3, the opposed surface 54A is provided with an irradiation opening 59 which is a rectangular opening communicating the inside and the outside of the drying unit housing 54. The irradiation opening 59 extends over substantially the entire opposed surface 54A in the left-right direction and is formed at a substantially central portion in the conveyance direction T of the opposed surface 54A. Note that the irradiation opening 59 may be closed by a member, such as a transparent member, capable of transmitting infrared light.

The drying unit 50 includes a heater 56 disposed inside the drying unit housing 54. The heater 56 includes, as a heat source, a heating element that generates heat, and dries the print medium 99 by heating the print medium 99 with that heat source.

The heater 56 includes a heating housing 58 formed like a housing that partitions an internal space S of the drying unit housing 54 to surround the irradiation opening 59. In the heating housing 58, the entire surface facing the support surface 52A forms the irradiation opening 59. The heating housing 58 is substantially the same in width dimension in the left-right direction as the drying unit housing 54, and is formed to be shorter in length dimension in the conveyance direction T than the drying unit housing 54. The heating housing 58 is disposed at a substantially central portion in the conveyance direction T of the drying unit housing 54.

Inside the heating housing 58, heater tubes 60, as the heater elements, linearly extending along the width direction of the print medium 99 and reflection plates 62 that reflect heat of the heating elements are housed. The heater tube 60 has substantially the same length dimension as that of the support surface 52A in the left-right direction, and each of end portions in the left-right direction is located at an outer side of each of both end portions in the width direction of the print medium 99 supported by the support surface 52A. Therefore, each of the heater tubes 60 is disposed at a position where the heater tube 60 overlaps the print medium 99 over the entire width direction of the print medium 99 in the left-right direction. In the present embodiment, two heater tubes 60 are arranged side by side along the conveyance direction T.

Note that in the present embodiment, the heater tube 60 is used as the heating element, but any member capable of heating the print medium 99 may be used.

The reflection plate 62 surrounds the heater tube 60 from the opposite side to the opposed surface 54A, and reflects infrared ray generated from the heater tube 60 toward the support surface 52A. In the reflection plate 62, a surface facing the heater tube 60 is formed as a parabolic reflection surface or an elliptical reflection surface, and a central axis P of the heater tube 60 is located at a focal point of the parabolic reflection surface or the elliptical reflection surface.

In the reflection plate 62, each of end portions 62A disposed at positions close to the support surface 52A extends to a position overlapping the irradiation opening 59.

The heater 56 heats the support surface 52A and a space between the drying unit 50 and the third support plate 52 by both the infrared rays emitted from the heater tubes 60 and the infrared rays reflected by the reflection plates 62 being emitted through the irradiation opening 59. In the following description, the support surface 52A and a space between the drying unit 50 and the third support plate 52 heated by the heater 56 are referred to as a heating region F.

Then, the drying unit housing 54 will be described in detail.

The drying unit housing 54 includes a first outer wall 70 that forms a surface located at an opposite side to the opposed surface 54A across the internal space S of the drying unit housing 54. The first outer wall 70 extends along the conveyance direction T. In the first outer wall 70, a second outer wall 72 extending toward the third support plate 52 is disposed at an end portion located upstream in the conveyance direction T, and a third outer wall 74 extending toward the third support plate 52 is disposed at an end portion located downstream in the conveyance direction T.

In the second outer wall 72, a portion closer to the third support plate 52 than the first outer wall 70 obliquely extends from upstream toward downstream in the conveyance direction T of the print medium 99 as proceeding from the first outer wall 70 toward the third support plate 52, and an end portion is located coplanar with the opposed surface 54A.

The third outer wall 74 rises from the first outer wall 70 and extends substantially perpendicular to the support surface 52A. In the direction in which the third outer wall 74 rises from the first outer wall 70, an end portion 74A located at an opposite side to the first outer wall 70 of the third outer wall 74 extends to a position closer to the support surface 52A than the opposed surface 54A. In the present embodiment, the end portion 74A is disposed at a position where a gap is formed between the end portion 74A and the support surface 52A to such an extent that the print medium 99 can pass through.

The third outer wall 74 is an example of a "second partition wall".

The drying unit housing 54 includes a pair of side walls 76 surrounding the internal space S from both sides in the left-right direction.

A partition wall 80 is disposed inside the drying unit housing 54. The partition wall 80 is formed like a plate that rises from the first outer wall 70 and extends substantially perpendicular to the support surface 52A, and is disposed between the heating housing 58 and the third outer wall 74 in the conveyance direction T. In the present embodiment, an end portion of the partition wall 80 located at an opposite side to an end portion coupled to the first outer wall 70 is located substantially coplanar with the opposed surface 54A.

In the drying unit housing 54, the opposed surface 54A is provided with a blast port 81. The blast port 81 is disposed at a position adjacent to the irradiation opening 59 from upstream in the conveyance direction T, and extends over substantially the entire opposed surface 54A in the left-right direction. The blast port 81 is surrounded by a guide wall 82, the second outer wall 72, and the pair of side walls 76 in the circumferential direction.

The guide wall 82 is disposed upstream in the conveyance direction T of the heating housing 58, and is formed in a plate shape rising from the opposed surface 54A toward the first outer wall 70. The guide wall 82 has a flat surface that extends substantially entire length in the left-right direction of the opposed surface 54A, and extends substantially in parallel to the second outer wall 72 in the vicinity of the blast port 81.

The opposed surface 54A is provided with an intake port 83. The intake port 83 is disposed at a position adjacent to the irradiation opening 59 from downstream in the conveyance direction T, and extends over substantially the entire length in the left-right direction of the opposed surface 54A. The intake port 83 is surrounded by the partition wall 80, the heating housing 58, and the pair of side walls 76 in the circumferential direction.

In the conveyance direction T, in the drying unit housing 54, the blast port 81 is disposed at a place located upstream of the heating region F, and the intake port 83 is disposed at a place located downstream of the heating region F.

A communication flow path S1 which is a space formed by being surrounded by the partition wall 80, the first outer wall 70, the second outer wall 72, the heating housing 58, and the side walls 76 is disposed inside the drying unit housing 54. In the conveyance direction T, the blast port 81 is located at one end portion located upstream of the communication flow path S1, and the intake port 83 is located at one end portion located downstream of the communication flow path S1. The communication flow path S1 communicates with the outside of the drying unit housing 54 via the blast port 81 and the intake port 83.

An attachment plate 84 as a plate-like member is disposed in the communication flow path S1. In a direction from the first outer wall 70 toward the support surface 52A, one end portion of the attachment plate 84 is coupled to the first outer wall 70 and the other end portion is coupled to the heating housing 58. In the left-right direction, both end portions of the attachment plate 84 are coupled to the side walls 76, respectively. Therefore, the attachment plate 84 partitions the communication flow path S1 into an upstream portion and a downstream portion in the conveyance direction T.

The attachment plate 84 is provided with a communication opening 85 that is a through hole penetrating in the plate thickness direction. The attachment plate 84 has a plurality of communication openings 85 arranged in the left-right direction.

A blower 86 is attached to the communication openings 85. When the blower 86 is driven, the blower 86 blows air in an opposite direction to the conveyance direction T. Accordingly, in the medium processing apparatus 16, a gas such as air is taken into the communication flow path S1 from the intake port 83, flows through the communication flow path S1, and is then discharged to the outside of the drying unit housing 54 from the blast port 81.

Note that the drying unit housing 54 is not limited to being provided with the blower 86, and may have any configuration as long as the gas can be blown in the opposite direction to the conveyance direction T in the communication flow path S1.

A louver 88 as a member shaped like a flat plate is disposed at a portion surrounded by the guide wall 82, the second outer wall 72, and the pair of side walls 76 in the communication flow path S1. A pair of planes of the louver 88 are disposed so as to face planes of the guide wall 82 and the second outer wall 72, respectively. The louver 88 obliquely extends from the first outer wall 70 toward the third support plate 52 as proceeding from upstream toward downstream along the conveyance direction T. Both end portions of the louver 88 in the left-right direction are coupled to the side walls 76, respectively.

In the drying unit housing 54, the opposed surface 54A is provided with a collection opening 87 as an opening. The collection opening 87 is disposed at a position adjacent to the intake port 83 from downstream in the conveyance direction T, and extends over substantially the entire length in the left-right direction of the opposed surface 54A. The collection opening 87 is located downstream of the intake port 83 in a direction in which the gas discharged from the blast port 81 flows along the print medium 99. The collection opening 87 is surrounded by the third outer wall 74, the partition wall 80, and the pair of side walls 76 in the circumferential direction.

A collection path S2 which is a space formed by being surrounded by the first outer wall 70, the third outer wall 74, the partition wall 80, and the pair of side walls 76 is disposed inside the drying unit housing 54. In the direction orthogonal to the support surface 52A, the collection opening 87 is located at one end portion of the collection path S2. It can also be said that the collection path S2 is located downstream of the intake port 83 in the direction in which the gas flows along the medium. The collection path S2 communicates with the outside of the drying unit housing 54 via the collection opening 87.

One of the pair of side walls 76 is provided with a discharge opening 91 that is a through hole penetrating the side wall 76 in the plate thickness direction. In the side wall 76, the discharge opening 91 is disposed at a position closer to the first outer wall 70 than the collection opening 87. Note that the discharge opening 91 may be provided to any of the first outer wall 70, the third outer wall 74, the partition wall 80, and the pair of side walls 76 as long as the position of the discharge opening 91 is closer to the first outer wall 70 than the collection opening 87.

One end portion of a connection tube 90 which is a tubular member is attached to the discharge opening 91, and a collection housing 92 which is a housing is attached to the other end portion of the connection tube 90. An internal space V of the collection housing 92 communicates with the collection path S2 via the connection tube 90 and the discharge opening 91.

The collection housing 92 is provided with a blower 94. When the blower 94 is driven, the blower 94 blows air from the collection path S2 toward the internal space V of the collection housing 92 via the discharge opening 91 and the connection tube 90. Accordingly, in the medium processing apparatus 16, the air or the gas located inside the collection path S2 flows into the collection housing 92.

The collection housing 92 may be provided with a cooling device such as a radiator that cools the air or the gas flowing into the internal space V. Further, for example, a collection container that collects components contained in the air and condensed by the cooling device may be coupled to the collection housing 92.

Then, an operation of the printing apparatus 1 will be described.

The print medium 99 printed by the printing unit 10 is conveyed by the conveyance unit 14 to a space between the third support plate 52 and the heater 56. When the print medium 99 is disposed in the heating region F, the print medium 99 is heated by the infrared rays emitted from the heater 56, and the ink is dried. In this case, the evaporation component of the ink evaporates and moves from the print medium 99 toward the drying unit 50 by buoyancy.

Here, in the drying unit 50, the blower 86 is driven to send the gas such as the air in the communication flow path S1 to the print medium 99 via the blast port 81. It is desirable that the guide wall 82 and a portion closer to the third support plate 52 than the first outer wall 70 out of the second outer wall 72 are disposed upstream in the conveyance direction T of the heating region F and at an inclination angle at which the gas sent by the blower 86 can be blown to the print medium 99. Similarly, it is desirable for the louver 88 to be disposed upstream in the conveyance direction T of the heating region F and at an inclination angle at which the gas sent by the blower 86 can be blown to the print medium 99. That is, it is desirable for the blast port 81 to blow the gas to the print medium 99 toward a position outside the heating region F.

Accordingly, in the medium processing apparatus 16, the gas blown out from the blast port 81 is suppressed from being blown to the heating region F. Therefore, in the medium processing apparatus 16, a decrease in the temperature of the heating region F is suppressed.

The blower 86 sends out the gas in the communication flow path S1 at a speed at which the gas blown out from the blast port 81 reaches the intake port 83 at a speed faster than a speed at which the evaporation component of the ink reaches the drying unit 50. The gas sent out in this manner is blown onto the print medium 99 upstream in the conveyance direction T of the heating region F, and then flows through the heating region F along the conveyance direction T. As a result, in the medium processing apparatus 16, it is suppressed that the gas to be sent out collides with the print medium 99 conveyed in the conveyance direction T to generate a positional deviation in the print medium 99.

The gas that has flowed through the heating region F along the conveyance direction T reaches downstream of the heating region F. Accordingly, the evaporation component of the ink reaches downstream of the heating region F together with the gas.

The end portion 74A of the third outer wall 74 is disposed with a gap between the end portion 74A and the support surface 52A to such an extent that the print medium 99 can pass through. Therefore, the evaporation component of the ink is blocked by the third outer wall 74.

The evaporation component of the ink blocked by the third outer wall 74 is drawn by the blower 94 into the collection path S2 together with the air or the like, and is further drawn into the collection housing 92.

As a result, in the printing apparatus 1, it is suppressed that the evaporation component of the ink is discharged to the outside of the printing apparatus 1. Therefore, in the printing apparatus 1, it is possible to suppress that the evaporation component of the ink is condensed outside the printing apparatus 1.

In the medium processing apparatus 16, a part of the gas flowing through the heating region F flows into the communication flow path S1 via the intake port 83. As described above, since most of the evaporation component of the ink is drawn into the collection path S2, the gas flowing into the communication flow path S1 via the intake port 83 is small in amount of evaporation component contained therein, dried, and high in temperature since the gas has passed through the heating region F. When the gas flows into the communication flow path S1, the gas is blown onto the print medium 99 from the blast port 81 by the blower 86.

As described above, in the medium processing apparatus 16, by taking the gas flowing through the heating region F into the communication flow path S1, the gas high in temperature and small in amount of the evaporation component contained, that is, the gas low in humidity can be sent out toward the print medium 99. Therefore, the medium processing apparatus 16 can suppress a decrease in temperature and an increase in humidity of the heating region F, and can more efficiently dry the ink on the print medium 99.

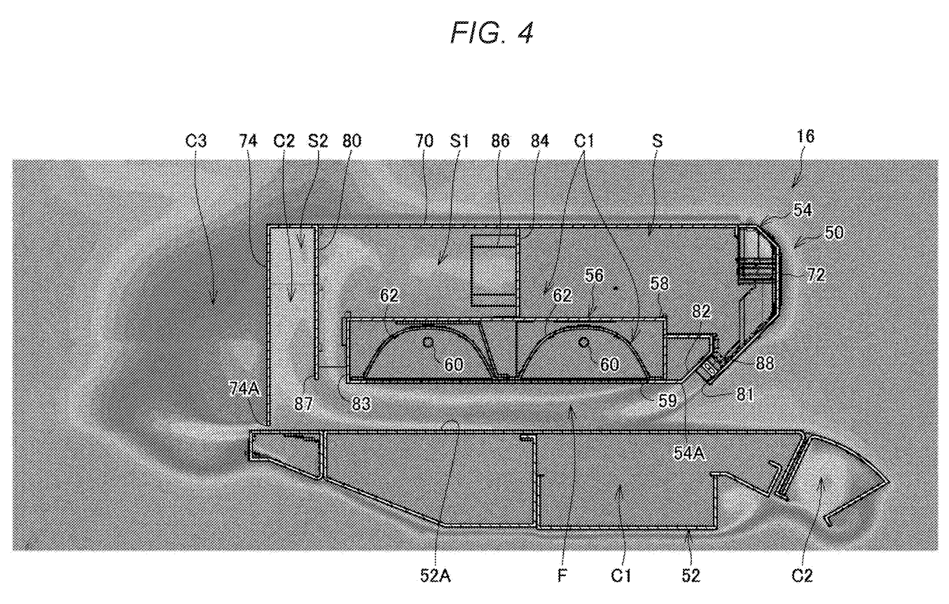

FIG. 4 is a temperature distribution diagram when the medium processing apparatus 16 is driven.

In FIG. 4, portions relatively high in temperature are indicated by high temperature portions C1, portions lower in temperature than the high temperature portion C1 are indicated by middle temperature portions C2, and portions lower in temperature than the middle temperature portion C2 are indicated by low temperature portions C3.

As illustrated in FIG. 4, in the medium processing apparatus 16, it is understood that the heater 56, the third support plate 52, and the communication flow path S1 are the high temperature portions C1. Therefore, it is understood that the medium processing apparatus 16 can take a high temperature gas into the communication flow path S1, send out the gas toward the print medium 99, and more efficiently dry the ink on the print medium 99.

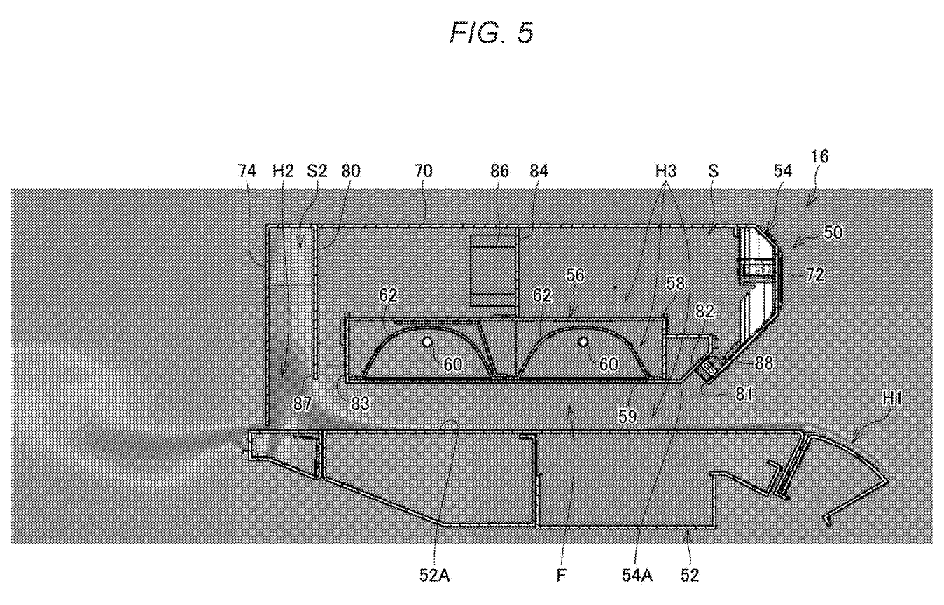

FIG. 5 is a humidity distribution diagram when the medium processing apparatus 16 is driven.

In FIG. 5, portions relatively high in humidity are indicated by high humidity portions H1, portions lower in humidity than the high humidity portion H1 are indicated by middle humidity portions H2, and portions lower in humidity than the middle humidity portion H2 are indicated by low humidity portions H3.

As shown in FIG. 5, in the medium processing apparatus 16, it is understood that the collection path S2 is the middle humidity portion H2. In contrast, in the medium processing apparatus 16, it is understood that the heating region F, the heater 56, the third support plate 52, and the communication flow path S1 are the low humidity portions H3. As a result, in the medium processing apparatus 16, the evaporation component relatively high in humidity can be sent out to the collection path S2, and the gas relatively low in humidity can be taken into the communication flow path S1. Therefore, it is understood that the medium processing apparatus 16 can feed out the gas toward the print medium 99 to more efficiently dry the ink on the print medium 99.

The embodiment described above exemplifies one aspect of the present disclosure, and can be modified and applied as appropriate without departing from the gist of the present disclosure.

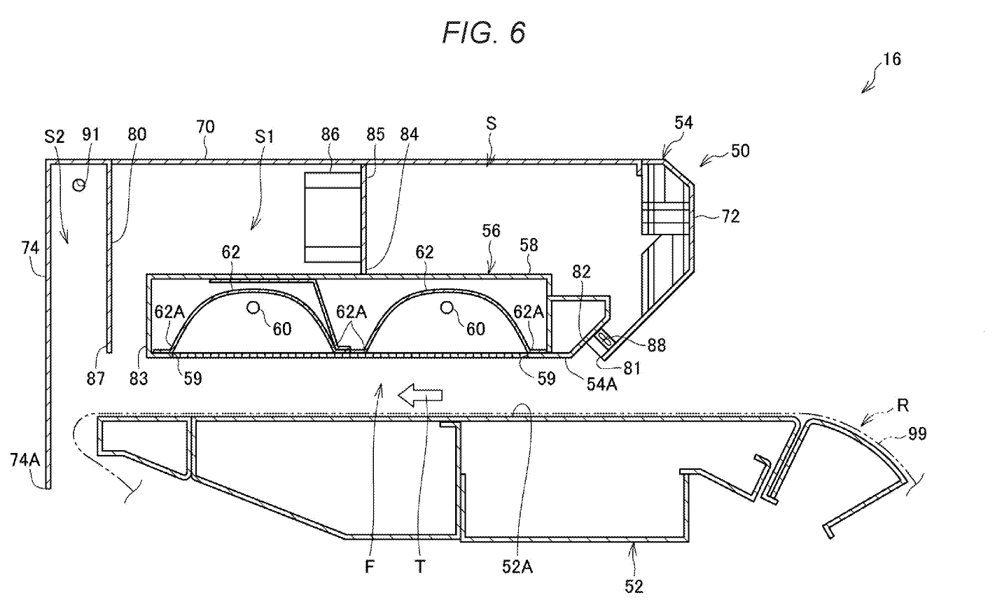

FIG. 6 is a side view illustrating the medium processing apparatus 16 according to a modified example of the present embodiment. In FIG. 6, a cross-section on a plane perpendicular to the left-right direction of the drying unit 50 is shown.

As illustrated in FIG. 6, the drying unit 50 may be disposed such that the third outer wall 74 is located downstream in the conveyance direction T of the end portion located downstream of the third support plate 52. In this case, the end portion 74A may be disposed at a position farther from the collection opening 87 than the support surface 52A in the direction orthogonal to the opposed surface 54A.

Accordingly, the medium processing apparatus 16 can more reliably block a larger amount of evaporation component of the ink with the third outer wall 74.

Note that when the medium processing apparatus 16 is formed in this manner, it is desirable that the print medium 99 conveyed on the conveyance path R is conveyed so as to avoid the third outer wall 74 by changing the direction in which the print medium 99 is conveyed at the end portion located downstream in the conveyance direction T of the third support plate 52.

In the portion closer to the third support plate 52 than the first outer wall 70 in the second outer wall 72, the end portion located at the opposite side to the first outer wall 70 may be closer to the support surface 52A than the opposed surface 54A. Thus, the blast port 81 is obliquely disposed toward the support surface 52A and the intake port 83. Therefore, the drying unit 50 can more efficiently feed out the gas along the conveyance direction T, and can feed out the evaporation component of the ink to downstream of the heating region F.

In the embodiment described above, it is assumed that the gas blown out from the blast port 81 is blown onto the print medium 99 upstream in the conveyance direction T of the heating region F. In this case, it is desirable that the gas blown out from the blast port 81 is blown onto the print medium 99 upstream in the conveyance direction T of the position where a straight line passing through the central axis P of the heater tube 60 and the end portion 62A of the reflection plate 62 crosses the support surface 52A. Accordingly, in the medium processing apparatus 16, it is possible to more reliably suppress that the temperature of the heating region F decreases.

The heater 56 may include just one heater tube 60 or three or more heater tubes 60. When three or more heater tubes 60 are provided in the heater 56, the plurality of heater tubes 60 may be arranged along the longitudinal direction of the heater tubes 60. Further, for example, the three or more heater tubes 60 may be arranged side by side along the conveyance direction T.

The support surface 52A may be a flat surface parallel to the opposed surface 54A or may be formed in a shape of a curved surface.

The drying unit 50 may be disposed integrally with the printing unit housing 40.

The blower 86 may be disposed inside the blast port 81 or inside the intake port 83.

The heating element provided to the heater 56 is not limited to the heater tube 60, and may be a heating wire, a heat source lamp, a lamp capable of emitting ultraviolet rays or electron beams, or the like.

The liquid jetted by the head 42 is not limited to the ink, and may be, for example, a liquid material obtained by dispersing or mixing particles of a functional material in a liquid. For example, the head 42 may jet a liquid material containing a material such as an electrode material or a color material (pixel material) used for manufacturing a liquid crystal display, an electroluminescence (EL) display, a surface emitting display, or the like in a dispersed or dissolved form.

The head 42 may be formed to cause the liquid to adhere to the print medium 99 by coming into contact with the print medium 99.

The head 42 may be of a line head type extending long in the width direction of the print medium 99.

The printing apparatus 1 may be a page printer configured to perform printing page by page.

The drying unit 50 may be used to promote drying of objects other than printed matters.

The print medium 99 is not limited to the print paper, and may be a plastic film such as a transfer film, a thin plate material, or the like, or may be fabric used in a textile printing apparatus or the like.

The directions such as the horizontal direction and the vertical direction and the various shapes in the embodiment described above include an equivalent range that achieves the same functions and advantages as those of the directions and shapes unless otherwise specified.

### Summary of Present Disclosure

The present disclosure will be summarized below as appendices.

### Appendix 1

A medium processing apparatus including: a medium support section configured to support a medium conveyed through a conveyance path; and a drying unit configured to face the medium support section across the medium supported by the

medium support section and dry ink adhering to the medium, wherein the drying unit includes a housing provided with a heater disposed at a distance from the medium and configured to heat the medium in a heating region, a blast port configured to send out a gas brown toward the medium and then flowing along the medium, an intake port configured to take in the gas passing through the heating region, a communication flow path configured to communicate the blast port and the intake port with each other to allow the gas to flow, and a collection path located downstream of the intake port in a direction in which the gas flows along the medium and configured to collect a part of the gas not taken in the intake port.

Accordingly, in the medium processing apparatus, since it is possible to collect a gas large in amount of vapor contained in the ink, it is possible to reduce the vapor discharged to the outside.

### Appendix 2

The medium processing apparatus according to Appendix 1, wherein the housing includes a first partition extending in a direction crossing a direction in which the gas flows and configured to separate the collection path and the intake port from each other, and a second partition wall extending in a direction crossing the direction in which the gas flows, and configured to cover the collection path from downstream in the direction in which the gas flows, and to be located downstream of the first partition wall, and the second partition wall extends to a position closer to the medium support section than the first partition wall.

Accordingly, in the medium processing apparatus, it is possible to collect the gas which is not taken into the intake port.

### Appendix 3

The medium processing apparatus according to Appendix 2, wherein the medium support section includes a support surface having an upper surface on which the medium is disposed, and the second partition wall is located downstream of one end portion of the support surface in a direction in which the gas flows, and extends to a position farther from the collection path than the support surface.

Accordingly, in the medium processing apparatus, a larger amount of gas that has not been taken into the intake port can be collected.

### Appendix 4

The medium processing apparatus according to any one of Appendices 1 to 3, wherein the blast port blows the gas to the medium toward a position outside a region to be heated by the heater.

Accordingly, in the medium processing apparatus, it is possible to blow air to the medium while suppressing a decrease in the temperature of the heating region.

### Appendix 5

The medium processing apparatus according to any one of Appendices 1 to 4, wherein the blast port is obliquely disposed toward a surface provided to the medium support section.

Accordingly, in the medium processing apparatus, the gas can be blown along the conveyance path.

### Appendix 6

The medium processing apparatus according to any one of Appendices 1 to 4, wherein the housing further includes, inside the blast port, a louver inclined with respect to a surface provided to the medium support section.

Accordingly, in the medium processing apparatus, the gas can be blown along the conveyance path.

### Appendix 7

A printing apparatus including: an ejection unit configured to eject ink onto a medium; a medium conveyance unit configured to convey the medium; a medium support section configured to support the medium conveyed through a conveyance path; and a drying unit configured to face the medium support section across the medium supported by the medium support section and dry the ink adhering to the medium, wherein the drying unit includes a housing provided with a heater disposed at a distance from the medium and configured to heat the medium in a heating region, a blast port configured to send out a gas brown toward the medium and then flowing along the medium, an intake port configured to take in the gas passing through the heating region, a communication flow path configured to communicate the blast port and the intake port with each other to allow the gas to flow, and a collection path located downstream of the intake port in a direction in which the gas flows along the medium and configured to collect a part of the gas not taken in the intake port.

As a result, in the printing apparatus, it is possible to collect the gas containing a larger amount of vapor and to reduce the vapor discharged to the outside of the apparatus.

What is claimed is:

1. A medium processing apparatus comprising:
a medium support section configured to support a medium conveyed through a conveyance path; and
a drying unit configured to face the medium support section and dry ink adhering to the medium, wherein
the drying unit includes a housing provided with
a heater disposed at a distance from the medium and configured to heat the medium in a heating region,
a blast port configured to send out a gas brown toward the medium and then flowing along the medium,
an intake port configured to take in the gas passing through the heating region,
a communication flow path configured to communicate the blast port and the intake port with each other to allow the gas to flow, and
a collection path located downstream of the intake port in a direction in which the gas flows along the medium and configured to collect a part of the gas not taken in the intake port.

2. The medium processing apparatus according to claim 1, wherein
the housing includes
a first partition wall extending in a direction crossing a direction in which the gas flows, and configured to separate the collection path and the intake port from each other, and
a second partition wall extending in a direction crossing the direction in which the gas flows, and configured to cover the collection path from downstream in the direction in which the gas flows, and to be located downstream of the first partition wall, and
the second partition wall extends to a position closer to the medium support section than the first partition wall.

3. The medium processing apparatus according to claim 2, wherein
the medium support section includes a support surface having an upper surface on which the medium is disposed, and
the second partition wall is located downstream of one end portion of the support surface in a direction in which the gas flows, and extends to a position farther from the collection path than the support surface.

4. The medium processing apparatus according to claim 1, wherein
the blast port blows the gas to the medium toward a position outside the heating region.

5. The medium processing apparatus according to claim 1, wherein
the blast port is obliquely disposed toward a surface provided to the medium support section.

6. The medium processing apparatus according to claim 1, wherein
the housing includes, inside the blast port, a louver inclined with respect to a surface provided to the medium support section.

7. A printing apparatus comprising:
an ejection unit configured to eject ink onto a medium;
a medium conveyance unit configured to convey the medium;
a medium support section configured to support the medium conveyed through a conveyance path; and
a drying unit configured to face the medium support section across the medium supported by the medium support section and dry the ink adhering to the medium, wherein
the drying unit includes a housing provided with
a heater disposed at a distance from the medium and configured to heat the medium in a heating region,
a blast port configured to send out a gas brown toward the medium and then flowing along the medium,
an intake port configured to take in the gas passing through the heating region,
a communication flow path configured to communicate the blast port and the intake port with each other to allow the gas to flow, and
a collection path located downstream of the intake port in a direction in which the gas flows along the medium and configured to collect a part of the gas not taken in the intake port.
